(19) United States
(12) Patent Application Publication
(10) Pub. No.: US 2007/0176028 A1
(43) Pub. Date: Aug. 2, 2007

(54) Nozzle arrangements

(76) Inventors: Keith Laidler, West Midlands (GB); Rajab Sharief, Manchester (GB); Hassan Abduljalil, Manchester (GB)

Correspondence Address: PEARSON & PEARSON, LLP, 10 GEORGE STREET, LOWELL, MA, 01852, US

(21) Appl. No.: 10/562,754

(22) PCT Filed: Jul. 2, 2004
(86) PCT No.: PCT/GB04/02898

§ 371 Date: Oct. 2, 2006

(30) Foreign Application Priority Data
Jul. 4, 2003 (GB) 0315664.3

(51) Int. Cl. A62C 31/02

(52) U.S. Cl. 239/589

(57) ABSTRACT

Nozzle arrangement for generating a spray of fluid comprise a body defining a flow passageway (10), which receives fluid from a supply via an inlet (11 or 12) and is configured to present a plurality of chambers (13, 16, 20) separated by constriction such as (15, 17). The chambers include expansion chambers such as (13, 20), and the constrictions may be associated with respective convergent and divergent passage sections (14, 19). The inner surfaces of the passageway or chambers, may be provide with small scale structures such as grooves, ribs, pits or protrusions.

The present invention relates to nozzle arrangements. More particularly, but not exclusively, the present invention relates to nozzle arrangements that are adapted to generate a spray of a fluid, which is forced to flow through the nozzle arrangement under pressure.

Nozzles are often used to provide a means of generating sprays of various fluids. In particular, nozzles are commonly fitted to the outlet valves of pressurised fluid-filled containers, such as so-called “aerosol canisters”, to provide a means by the fluid stored in the container can be dispensed in the form of a spray or mist. A large number of commercial products are presented to consumers in this form, including, for example, antiperspirant sprays, deodorant sprays, perfumes, air fresheners, antiseptics, paints, insecticides, polish, hair care products, pharmaceuticals, water and lubricants. In addition, pump or trigger-actuated nozzle arrangements, i.e. arrangements where the release of fluid from a non-pressurised container is actuated by the operation of a manually operable pump or trigger that forms an integral part of the arrangement, are also frequently used to generate a spray or mist of certain fluid products. Examples of products that typically incorporate pump or trigger nozzle devices include various lotions, insecticides, as well as various garden and household sprays.

A spray is generated when a fluid is caused to flow through a nozzle arrangement under pressure. To achieve this effect, the nozzle arrangement is configured to cause the fluid stream passing through the nozzle to break up or “atomise” into numerous droplets, which are then ejected through an outlet of the arrangement in the form of a spray or mist.

The optimum size of the droplets required in a particular spray depends primarily on the particular product concerned and the application for which it is intended. For example, a pharmaceutical spray that contains a drug intended to be inhaled by a patient (e.g. an asthmatic patient) usually requires very small droplets, which can penetrate deep into the lungs. In contrast, a polish spray preferably comprises spray droplets with larger diameters to promote the impaction of the aerosol droplets on the surface that is to be polished and, particularly if the spray is toxic, to reduce the extent of inhalation.

The size of the aerosol droplets produced by such conventional nozzle arrangements is dictated by a number of factors, including the dimensions of the outlet orifice and the pressure with which the fluid is forced through the nozzle. However, problems can arise if it is desired to produce a spray that comprises small droplets with narrow droplet size distributions, particularly at low pressures. The use of low pressures for generating sprays is becoming increasingly desirable because it enables low pressure nozzle devices, such as the manually-operable pump or trigger sprays, to be used instead of more expensive pressurised containers and, in the case of the pressurised fluid-filled containers, it enables the quantity of propellant present in the spray to be reduced, or alternative propellants which typically produce lower pressures (e.g. compressed gas) to be used. The desire to reduce the level of propellant used in aerosol canisters is a topical issue at the moment and is likely to become more important in the future due to legislation planned in certain countries, which proposes to impose restrictions on the amount of propellant that can be used in hand-held aerosol canisters. The reduction in the level of propellant causes a reduction in the pressure available to drive the fluid through the nozzle arrangement and also results in less propellant being present in the mixture to assist with the droplet break up. Therefore, there is a requirement for a nozzle arrangement that is capable of producing an aerosol spray composed of suitably small droplets at low pressures.

A further problem with known pressurised aerosol canisters fitted with conventional nozzle arrangements is that the size of the aerosol droplets generated tends to increase during the lifetime of the aerosol canister, particularly towards the end of the canisters life as the pressure within the canister reduces as the propellant becomes gradually depleted. This reduction in pressure causes an observable increase in the size of the aerosol droplets generated and thus, the quality of the spray produced is compromised.

Accordingly, it is an object of the present invention to provide a nozzle arrangement that is adapted to generally reduce the size of the droplets generated when compared with conventional nozzle devices, as well as reduce the droplet size distributions. In addition, it is an object of the present invention to provide a nozzle arrangement that is adapted to enable small droplets of fluid to be generated at low pressures, i.e. when fluids containing reduced or depleted levels of propellant, or a relatively low-pressure propellant such as compressed gas, is used, or a low-pressure system is used, such as a pump- or trigger-actuated nozzle arrangement.

The problem of providing a high quality spray at low pressures is further exacerbated if the fluid concerned has a high viscosity because it becomes harder to atomise the fluid into sufficiently small droplets.

Accordingly, it is a further object of the present invention to provide a nozzle arrangement that is capable of generating a spray from a viscous fluid at low pressures.

Some known nozzle arrangements incorporate expansion chambers formed as widenings in the passageway and these are, within the limited of accuracy of machining of a generally cylindrical profile.

In the case of nozzles fitted to pressurised aerosol canisters, there is also a tendency for the fluid flow through the nozzle to reduce as the contents present in the canister become depleted. As previously indicated, this is primarily due to the depletion of the propellant present in the canister and can be particularly undesirable because it results in the quality of the spray produced by the nozzle arrangement being compromised as the canister approaches the end of its operational lifetime.

For this reason, it is a further object of the present invention to means by which the level of fluid flow through a nozzle arrangement can be maintained at a constant or substantially constant level.

According to the present invention there is provided a nozzle arrangement adapted to be fitted to an outlet of a fluid supply and generate a spray of fluid dispensed from said fluid supply during use, said nozzle arrangement having a body which comprises:
(i) actuator means which is adapted, upon operation, to cause fluid to flow from said fluid supply and through said nozzle arrangement;
(ii) an inlet through which fluid from said fluid supply accesses the nozzle arrangement during use;
(iii) an outlet through which fluid is ejected from the nozzle arrangement during use; and
(iv) an internal fluid flow passageway which connects said inlet to said outlet;
said fluid flow passageway comprising a shaped expansion chamber.

A shaped expansion chamber disposed at a position along the length of the fluid flow passageway may be provided, said chamber having a constricted inlet, through which fluid flowing through the passageway during use accesses the chamber, and a constricted outlet, through which fluid exits the chamber during use.

By “shaped” we mean that the chamber consists of more than a simple cylindrical cavity and may include tapered or constricted parts, and parts of non-circular cross section.

By “constricted” we mean that the opening defined by the inlet and outlet respectively is narrower than the bore of the internal fluid flow passageway, through which the fluid flows into and out of the chamber.

The provision of a chamber having a constricted inlet and outlet has surprisingly been found to contribute to the atomisation of droplets of viscous solutions.

Preferably the passageway further comprises a swirl chamber positioned downstream of the chamber. In one embodiment, the chamber may be a series of sub-chambers separated by constrictions and be followed by a swirl chamber positioned downstream of the expansion chamber.

It is especially preferred that such an expansion chamber is fed by a tangential fluid stream input which may be additional to an axial inlet.

By “tangentially”, we mean that the fluid flows into the inlet end of the elongate portion along a tangent with respect to its cross-sectional profile, i.e. its profile at an angle which is perpendicular or substantially perpendicular to the longitudinal axis of the elongate portion of the passageway. In most cases, it is preferred that the fluid flow passageway is circular or substantially circular in cross-section so that the introduction of fluid tangentially means that the fluid stream enters the inlet end and is directed towards the circular or substantially circular internal wall, thereby causing the fluid to swirl within the elongate portion as it continues to flow towards the outlet of the nozzle arrangement. Imparting rotational flow to the fluid stream in this manner has been found to enhance the break up or “atomisation” of fluid droplets flowing through the passageway and, ultimately, ejected through the outlet. Hence, nozzle arrangements configured in this manner can improve the quality of the spray generated (i.e. provide small droplets at reduced pressures with narrow droplet size distributions).

For the avoidance of doubt, an expansion chamber is an internal chamber, usually (but not necessarily) circular in cross-section, into which fluid passing though the passageway enters through an inlet orifice. In addition, a swirl chamber is an internal chamber that is configured to impart a rotational and/or swirling motion to the fluid stream passing through the chamber during use. Expansion chambers and swirl chambers are further defined in WO 01/89958, the entire contents of which are incorporated herein by reference.

Preferably, the walls defining the interior of the chamber taper towards a constriction in the chamber and taper outwards from the constriction thereby defining sub-chambers in the form of truncated cones.

The fluid entering the expansion chamber may be directed to an internal wall of the chamber, rather than towards an outlet orifice of the chamber. This ensures that the fluid droplets are exposed to as much disruption as possible within the chamber to atomise the droplets as far as possible.

The internal chamber may have one or more inlet orifices and one or more outlet orifices, said inlet orifices being arranged in a divergent relationship to one another so that the fluid passing through the internal passageway accesses the chamber through said two or more inlet orifices along two or more independent and divergent paths.

Preferably, the divergent inlet orifices direct fluid towards the internal walls and/or corners of the chamber (rather than the opening of the outlet orifice(s)). It is also preferable that the fluid entering the chamber is directed towards an opposing wall of the expansion chamber or the corner between an opposing wall and an adjacent wall of the expansion chamber, rather than the same wall that comprises the inlet orifice(s), or a wall that is directly adjacent to such a wall. Alternatively, one or more posts or protrusions may be positioned within the chamber to provide internal wall surfaces which the fluid may be directed towards.

It is especially preferred that the fluid is directed towards one or more nodules formed on the internal walls and/or corners of the expansion chamber, said nodules being configured to cause further agitation/disturbance to the fluid stream within the chamber (and hence, further atomise the fluid droplets present in the fluid stream).

Preferably, the fluid is sprayed into the internal chamber through the inlet orifices.

In some embodiments the one or more outlet orifices direct fluid present in the chamber into a continuation of the internal fluid flow passageway. It is preferable, however, that the chamber is disposed proximate to the outlet and the one or more outlet orifices of the expansion chamber are also the one or more outlet orifices of the nozzle arrangement.

Alternatively, the internal chamber may be provided with two or more inlet orifices disposed in a convergent relationship with respect to one another so that the fluid streams flowing through the inlet orifices into the chamber are directed towards one another and mix within the chamber. This mixing of fluid streams further contributes to the atomisation of the fluid flowing through the nozzle arrangement during use.

The passageway may comprise a first orifice-defining portion and a flap having a second orifice-defining portion, said flap being configured to be displaced by the flow of fluid through the internal passageway during use from a first position, in which said flap resides when the nozzle arrangement is not in use and wherein the first and second orifice-defining portions are disposed apart from one another, to a second position, in which said first and second orifice-defining portions are disposed proximate to one another and together define an orifice though which the fluid passing through the nozzle arrangement must pass.

The parts of a nozzle arrangement most likely to become clogged with matter during use are the narrow/constricted portions, such as internal or external orifices. For this reason, the provision of an orifice defined by two (or more) orifice-defining portions, at least one of which is provided on a moveable flap so that it is in its orifice-defining position when the nozzle arrangement is in use (i.e. when fluid is flowing through the nozzle arrangement), but can move away when the nozzle arrangement is not in use to provide a means by which any matter that has become lodged at the orifice can be dislodged. In effect, the orifices are self-cleaning and the build up of residue at the orifices of a nozzle arrangement is dramatically reduced.

The fluid supply may be any suitable fluid supply to which a nozzle arrangement is usually attached. In most cases the fluid supply will be container, such as pressurised hand-held aerosol canister.

The nozzle arrangements of the present invention are preferably formed from plastic.

It is also preferable that the body of the nozzle arrangements of the present invention is composed of at least two interconnected parts. Each part preferably has an abutment surface, which may be brought into contact with one another to form the final nozzle arrangement assembly. One or more of the abutment surfaces preferably comprise grooves and recesses formed thereon which, when the surfaces are brought into contact, define the fluid flow passageway (including any chambers positioned along its length), as well as the outlet and, optionally, the inlet. Preferably, a seal is provided between the abutment surfaces, which prevents fluid passing through the nozzle arrangement from leaking out between the abutment surfaces during use. This construction is preferred because it can be manufactured very cheaply and with a high degree of precision. In addition, the constituent parts of the body may be permanently fixed together to form the final, assembled nozzle arrangement or, alternatively, the parts may remain separable so that fluid flow passageway may be opened and exposed for cleaning. Most preferably, the nozzle arrangement is formed of two parts interconnected by a hinge so as to enable the respective parts to be moved towards or away from each other to enable cleaning to be effected.

In a further development of the invention, one or more of said internal chambers is configured to have a width extending transversely of the flow passage and in the plane of the abutment surface of the two parts of the nozzle arrangement, and a depth perpendicular to said plane which is greater than said width.

Preferably the internal chamber has curved interior surfaces defining an elliptical cross-section to said chamber, the major axis of which constitutes the depth.

Alternatively the internal chamber has planar interior surfaces defining a rectangular or other polygonal cross-section to said member.

Two or more said chambers may extend in parallel and be provided in independent multiple inventions of said flow passage.

Nozzle arrangements of this construction are described further in WO 01/89958 and WO 97/31841, the entire contents of which are incorporated herein by reference.

The actuator means may be any suitable actuator means that is capable of initiating the flow of fluid through the nozzle arrangement. Various means are well known in the art. For example, nozzle arrangements fitted to pressurised fluid-filled canisters typically comprise and actuator that can be depressed so as to engage and open the outlet valve of the canister and thereby permit the fluid stored therein to be dispensed through the nozzle arrangement. In addition, pump and trigger nozzle arrangements are widely available as a means for dispensing fluids from non-pressurised containers. In these cases, the operation of the pump or trigger generates the pressure, which causes the fluid from the container to be dispensed through the nozzle arrangement.

How the invention may be put into practice will now be described in more detail in reference to the following Figures, in which:

FIGS. 1 to 9 are diagrammatic cross-sectional views of shaped expansion chambers in nozzle arrangements according to the invention;

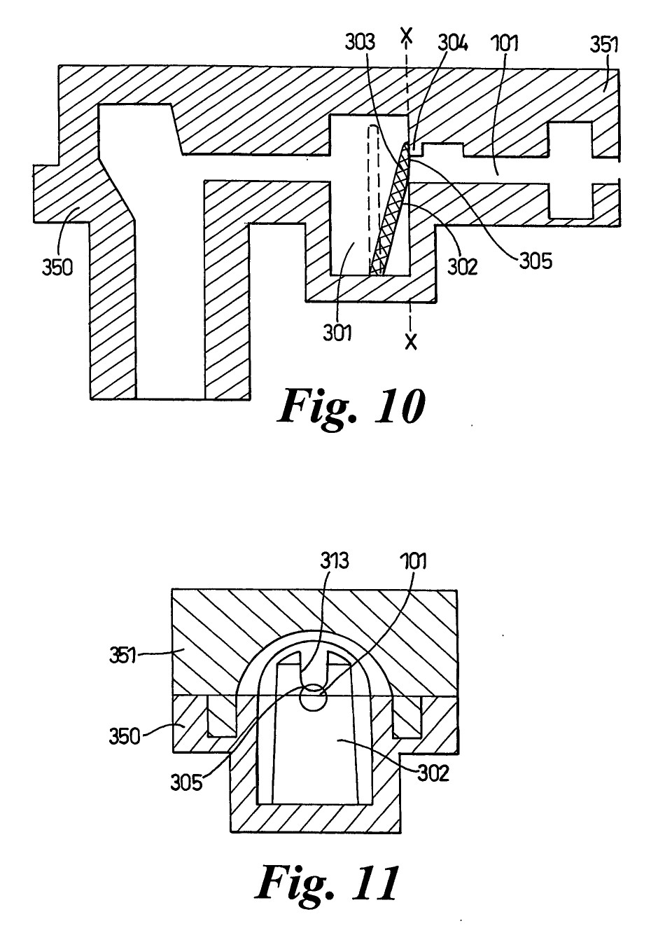

FIG. 10 is a longitudinal cross-section;

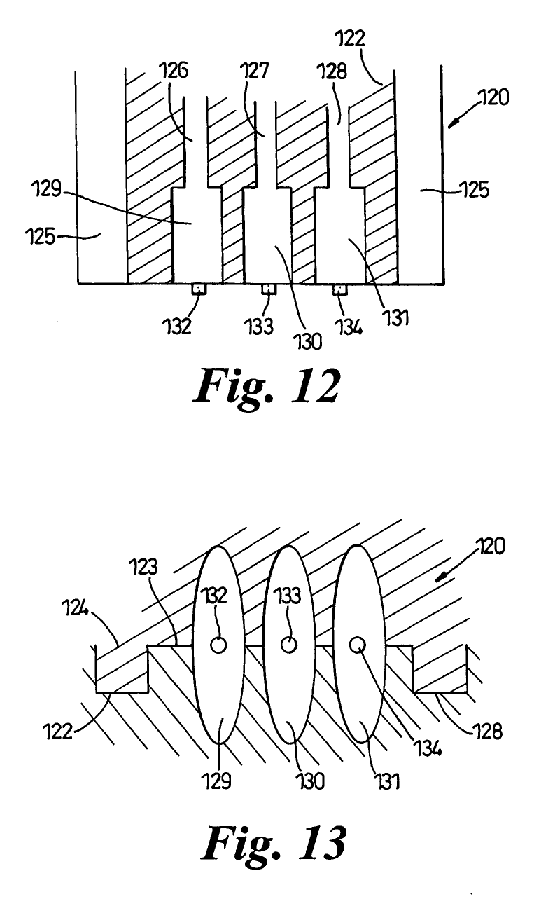

FIG. 11 is a transverse cross-section on base X-X of FIG. 10 of a further nozzle arrangement according to the invention; and

FIGS. 12 and 13 are respective longitudinal and vertical cross-sections of an alternative type of chamber in multiple parallel flow paths.

A nozzle arrangement according to the invention as shown in FIG. 1 includes a flow passage which has an axial inlet port 11 or a tangential inlet port 12 leading into a first expansion chamber 10, that is a part of the passage 10 having a greater diameter from the inlet port 11 or 12. The chamber 10 has a first section 13 of constant diameter which merges with a second section 14 converging towards a constriction 15, in the direction of flow. The shaped chamber 10 then includes a further space 16, followed by a further constriction 17, from which fluid enters a final sections 18 of the chamber via a divergent or flared section 19, leading to a section 20 of constant diameter, and hence to a discharge orifice 21 which presents a final constriction.

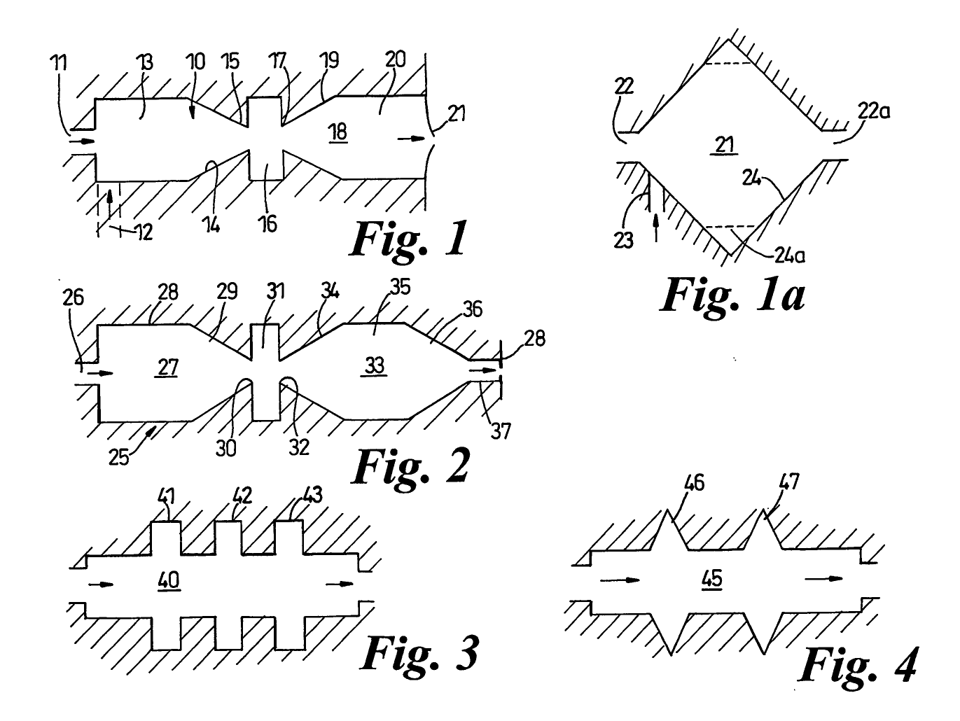

A modified nozzle arrangement according to the invention is shown in FIG. 2, and this comprises a shaped chamber 25 which has an axial inlet port 26 leading into a first section 27 having a section 28 of constant diameter which merges with a second section 29 which converges towards a constriction 30. As in the FIG. 1 embodiment, the constriction 30 is immediately followed in the feed direction by a further, short wide section 31, followed by a further constriction 32 from which fluids enters a final wider section 33 via a divergent or flared section 34 leading to a section 35 of constant diameter. The section 33 then has a convergent section 36 which leads to an outlet passage 37 and discharge orifice 38.

FIG. 1a shows another form of shaped expansion chamber 21 characterising the nozzle arrangement according to the invention. The chamber 21 comprises an axial inlet 22 from the passageway, and an axially aligned outlet 22a at the downstream end of the chamber 21. The chamber 21 is shaped to form a double frusto-conical volume with divergent/reconvergent surfaces 24 of the chamber. A second or alternative tangential inlet 23 for fluid or for a second fluid (such as gas, e.g. air, where the inlet 22 admits a liquid medium) is or may be provided opening into the chamber 21 through the divergent part of the chamber wall.

In variants of this form of chamber 21 the form of the divergent/reconvergent surfaces 24 may be modified, for example by being deepened relative to the configuration shown in FIG. 1a or alternatively provided at the maximum diameter with a cylindrical surface, giving a flat-bottomed V or U cross-section, for example as shown by dashed line 24a. This latter surface may be of any relative length.

FIGS. 3 to 9 illustrate sections of shaped chambers, showing different optional configurations of shaped expansion chambers which may be used alone or in any combination including with chambers of the types shown in FIGS. 1 and 2, or which other means such as swirl chambers which are known in the art.

FIG. 3 shows a shaped chamber 40 having a first diameter, which enters in turn three larger diameter parts 41, 42, 43 each of which may be regarded as a rectangular cross-sectional groove which may be of any suitable depth. The number of course is only given by way of example, and there may be one, two, three or more such grooves or widened parts. Similarly FIG. 4 shows a shaped chamber 45, which enters in turn for example two widened parts 46, 47 which may be regarded as deep v-cross-sectioned grooves. Here again the chambers or grooves 46, 47 may be provided in any desired number, and successive grooves need not be of the same depth or axial length as the chamber 45. The grooves could run parallel to the axis of the chamber instead of around the circumference.

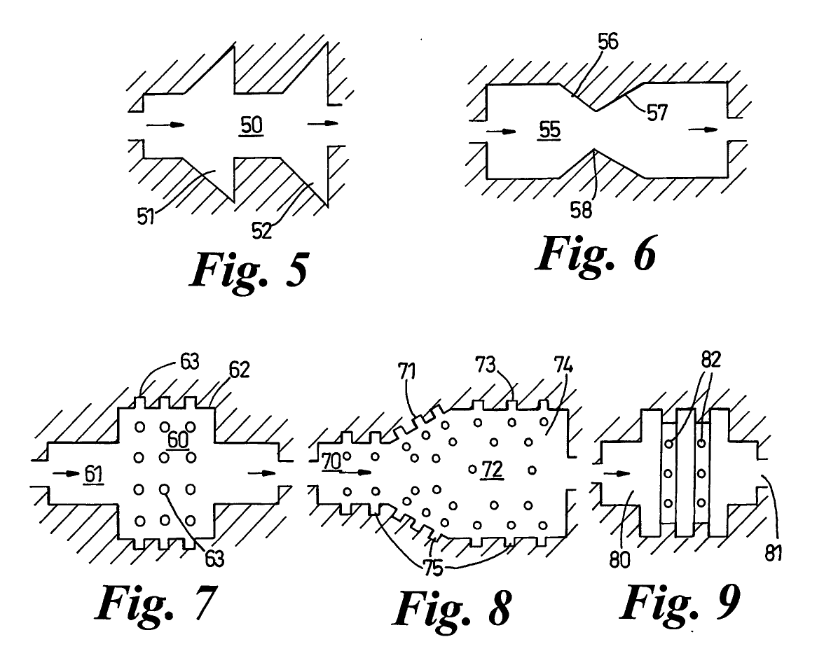

FIG. 5 shows a variant wherein a shaped expansion chamber 50 enters flared sections 51, 52. The last section 52 may be connected to a further section of the chamber 50 or lead to an outlet orifice, such as 21 shown in FIG. 1. Chamber 50 could be a tubular expansion chamber, a shaped expansion chamber or even a channel. FIG. 6 shows a shaped chamber 55 which incorporates a constriction, comprising a convergent section 56, and a divergent section 57 separated by an annular edge 58. The constriction differs from a venturi in that the latter has curved convergent and divergent surfaces, which merge smoothly and usually conform to a rotational solid defined by an elliptical section e.g. a parabolic curve, and without any angle between surfaces forming an annular edge which introduces turbulence onto the fluid stream. The latter is usually considered undesirable. In a dispenser however, turbulence is sometimes sought as a means for breaking up entrained droplets in a spray for example. The chamber 55 may be a standard cylindrical chamber or be shaped and incorporate features such as shown in any of the other Figures.

FIG. 7 illustrates in sectional view shaped expansion chamber 61, having a widened section 60, wherein the peripheral surface 62 of the expansion chamber is formed with a plurality of pits or holes 63.

FIG. 8 shows an embodiment with a chamber which may be shaped, or a standard cylindrical chamber 72 wherein a narrower first part 70, the divergent walls 71 of a flared section of the chamber 72 and the parallel walls 73 of a wider constant diameter section 74 of the expansion chamber 72 are each formed with a plurality of holes or pits 75.

Finally FIG. 9 shows a variant of the FIG. 7 embodiment wherein a shaped expansion chamber 80, connected to a flow passage 81, is formed with inwardly extending protrusions or posts on the peripheral surface of a widened part 83 of the expansion chamber.

FIG. 10 shows an embodiment of a modified nozzle arrangement according to the present invention. The nozzle arrangement is formed from a base part 350 and an upper part 351. In this embodiment, however, the fluid flow passageway 101 comprises a shaped expansion chamber 301 which comprises an upstanding flap 302 mounted therein. The flap has an orifice defining end portion which, together with the orifice-defining portion of the body, defines an internal orifice 305. The flap 302 is configured to be resiliently deformed by the flow of fluid through the nozzle arrangement during use from the first position (not shown), whereby the orifice defining portion 303 of the flap is displaced from the orifice defining portion 304 of the body, to a second position, whereby the orifice-defining portions of the flap and body, 303 and 304 respectively, are disposed proximate to one another, as shown in FIG. 3A, and together define an internal orifice 305 through which fluid must pass during use.

FIG. 11 shows a cross-sectional view taken along line X-X of FIG. 10. In this figure the upper part 351 and the base part 350 can be clearly seen. The upstanding flap 302 has as its orifice-defining portion a cut away portion 313. The lower edge of cut-away portion 313 forms the orifice 305 through which fluid exiting the chamber 301 must pass.

It should of course be appreciated that once the flow of fluid ceases through the nozzle arrangement, the flap returns to the first position by virtue of its inherent resilience. This causes any residue that may have built up at the internal orifice to become dislodged.

The flow passage of the FIG. 10 and 11 embodiments may include expansion chambers and/or constrictions of any of the types described with reference to FIGS. 1 to 9.

FIG. 12 is a longitudinal and FIG. 13 a vertical cross-section of a further embodiment of the invention. The figures show three expansion chambers forming a section of a flow passage in a nozzle arrangement 120. The nozzle arrangement 120 consists of an upper part 121 and a lower part 122 with an interface 123 defining a plane. The parts 121, 122 are located together by means of a rib 124 received in a groove 125. The parts 121, 122 have grooves and depressions thereon which together define a flow passageway through the nozzle arrangement 120. In the region of the fragmentary part shown, the flow passageway is subdivided into three parallel independent flow conduits 126, 127 and 128. Each of the conduits enters a respective expansion chamber 129, 130, 131, which also have exits 132, 133, 134 which may if desired be outlets from the nozzle or lead directly or indirectly to a reunited passageway or continue as separate paths to the outlets.

The expansion chambers 129, 130, 131 are remarkable in that they have an elliptical cross-section, with the major axis extending perpendicularly to the plane defined by the interface 123. The expansion chambers could be provided with planar internal surfaces forming rectangular or polygonal chambers. As shown the chambers have considerable elongation on the major axis, e.g. about 5:1 which enables a substantial chamber volume to be attained whilst enabling parallel chambers to be used, which is not possible with conventionally formed chambers because of lack of space.

The chamber design may also be applied to other features such as swirl chambers, and the expansion chambers may be varied from those shown, e.g. with tangential inlet feed rather than axial, and be formed with single or multiple throttles.

The chambers may be set in divergent paths, or have divergent inlet and outlet orifices, or be offset with respect to each other to create more space for e.g. larger chambers.

A nozzle arrangement according to any of the described embodiments is, in use, fitted to an outlet of a dispenser container and serves to generate a spray of fluid dispensed from the container and as well as the passageways described in detail above, includes an actuator to cause fluid to flow from the container into the nozzle arrangement, to the inlet of the nozzle arrangement, through the passageway and out from an outlet orifice provided by the nozzle arrangement.

FIG. 1a indicates that two different fluid streams e.g. one liquid, one gas or two different liquids, may be mixed in the chamber, having both an axial feed and a tangential feed to the chamber. It should be noted that any of the other embodiments shown in the drawings may also be modified to provide either a tangential feed inlet on its own, or both axial and tangential feeds to allow mixing of different fluids.

The nozzle arrangement may also include provision for by-pass passages as a branch of the passageway, or to feed a second fluid to another part of the nozzle bypassing one or more chambers.

The nozzle arrangements described are usually made from plastics material, but may instead be formed from suitable metal, or comprise nozzles inserted into the dispenser arrangement.

The configurations such as grooves, or pits or protrusions shown in the chamber may also be included in other parts of the passageway, preferably on a reduced scale.

1. A nozzle arrangement adapted to be fitted to an outlet of a fluid supply and to generate a spray of fluid dispensed from said fluid supply during use, said nozzle arrangement having a body which comprises:
(1) actuator means which is adapted, upon operation, to cause fluid to flow from said fluid supply and through said nozzle arrangement;
(2) an inlet through which fluid from said fluid supply accesses the nozzle arrangement during use;
(3) an outlet through which fluid is ejected from the nozzle arrangement during use; and
(4) an internal fluid flow passage which connects said inlet to said outlet;
characterised in that said fluid flow passageway includes a chamber and at least one spray orifice downstream of the chamber, said spray orifice having a cross-sectional area smaller than the cross-sectional area of any part of the chamber, the chamber being a non-planar expansion of the passageway and having at least one inlet orifice, the chamber being shaped such that its width is varied at least twice along its length.

2. A nozzle arrangement according to claim 1, wherein said shaped chamber comprises a first section having divergent walls immediately followed by a second section, downstream of the first section, said second section having convergent walls.

3. A nozzle arrangement according to claim 1, wherein said shaped chamber comprises a first section having divergent walls and a second section, downstream of the first section, having convergent walls, said divergent and convergent wall sections being separated by a third wall section of constant width.

4. A nozzle arrangement according to claim 1, wherein said shaped chamber comprises an internal chamber disposed at a position along the length of the fluid flow passageway, and having a constricted inlet, through which fluid flowing through the passageway during use accesses the chamber, and a constricted outlet, through which fluid exits the chamber during use.

5. A nozzle arrangement according to claim 1 or 4, wherein said shaped chamber comprises a series of sub-chambers connected between the at least one inlet orifice and at least one outlet orifice, constrictions therebetween having a greater cross-sectional area than the or each inlet orifice and the or each outlet orifice.

6. A nozzle arrangement according to claim 5, comprising, in the direction of flow through the chamber, a first section of constant width, a second section having convergent walls in which the width of the chamber is reduced in the direction of flow, a third section or intermediate sub-chamber of constant width, a fourth section having divergent walls in which the width of the chamber is increased in the direction of flow, and a fifth section of constant width leading to an outlet orifice, the width of the intermediate sub-chamber being greater than that of the narrowest parts of the second and fourth sections that lead into and out of the intermediate sub-chamber.

7. A nozzle arrangement according to claim 6, further comprising a sixth section between the fifth section and the outlet orifice, said sixth section having convergent walls in which the width of the chamber is reduced in the direction of flow.

8. A nozzle as claimed in claim 6 or claim 7, in which the width of the chamber is the same in the first, third and fifth sections.

9. A nozzle arrangement according to claim 1, wherein one or more recesses are provided in the surface of the chamber, the, or each, recess defining a region of increased width with respect to the remainder of the chamber.

10. A nozzle arrangement according to claim 9, wherein the, or each, recess comprises a rectangular cross-sectioned groove.

11. A nozzle arrangement according to claim 9, wherein the, or each, recess comprises a generally v-shaped cross-sectioned groove.

12. A nozzle arrangement according to claim 9, wherein the, or each, recess comprises a generally triangular cross-sectioned groove.

13. A nozzle arrangement according to any preceding claim, comprising a constriction within said shaped expansion chamber, said constriction comprising a first section having convergent walls immediately followed by a second section having divergent walls downstream of the first section.

14. A nozzle arrangement according to any preceding claim, wherein at least part of the interior surface of the shaped chamber is formed with holes or pits.

15. A nozzle arrangement according to any preceding claim, wherein at least part of the interior surface of the shaped chamber is formed with shaped elevated sections or protrusions.

16. A nozzle arrangement as claimed in any preceding claim, in which the transverse cross-section of the chamber at any given point along its length is generally circular.

17. A nozzle arrangement as claimed in claim 16, in which portions of the chamber having convergent or divergent walls define a generally frusto-conical volume.

18. A nozzle arrangement according to any preceding claim, said nozzle being composed of at least two parts, each part having an abutment surface which are brought into contact with one another to form the nozzle, in which grooves and/or recess are formed on at least one of the abutment surfaces, said grooves and/or recess defining the fluid flow passageway.

19. A nozzle arrangement according to claim 18, wherein one or more of said internal chambers is configured to have a width extending transversely of the flow passage and in the plane of the abutment surfaces of the two parts of the nozzle arrangement, and a depth perpendicular to said plane, which is greater than said width.

20. A nozzle arrangement according to claim 19, wherein said internal chamber has curved interior surfaces defining an elliptical cross-section to said chamber the major axis of which constitutes the depth.

21. A nozzle arrangement according to claim 19, wherein said internal chamber has planar interior surfaces defining a rectangular or other polygonal cross-section to said chamber.

22. A nozzle arrangement according to any preceding claim, in which two or more shaped chambers are provided in independent multiple flow parts of said flow passageway.

23. A nozzle arrangement according to any preceding claim, comprising two or more of said shaped chambers connected in series.

24. A nozzle arrangement according to claim 23, wherein other passageway features are provided connected between said series connected chambers.

25. A nozzle arrangement as claimed in any preceding claim, in which at least one inlet orifice is provided in an upstream end of the chamber and is arranged to direct fluid into the chamber in a generally longitudinal direction thereof.

26. A nozzle arrangement as claimed in claim 25, in which the at least one inlet orifice is arranged to direct fluid into the chamber substantially in-line with or parallel to the longitudinal axis.

27. A nozzle arrangement as claimed in claim 25, in which the at least one inlet orifice is arranged to direct fluid into the chamber at an angle to the longitudinal axis of the chamber.

28. A nozzle arrangement as claimed in claim 27, in which there are at least two inlet orifices, the orifices being aligned such that the respective fluid streams entering the chamber are directed along mutually convergent or mutually divergent paths.

29. A nozzle arrangement as claimed in any preceding claim, in which one or more inlet orifices are provided in a side of the chamber proximal the upstream end so as to direct fluid general transversely across the chamber.

30. A nozzle arrangement as claimed in claim 29, in which at least one of the side inlets is arranged to direct fluid into the chamber tangentially.

31. A nozzle arrangement as claimed in any preceding claim, in which the chamber has two or more inlet orifices, at least one of the inlet orifices being adapted to direct a liquid into the chamber and at least one other of the inlet orifices being arranged to direct a gas into the chamber.

32. A nozzle arrangement as claimed in any previous claim, in which the, or each, spray orifice comprises an outlet of the shaped chamber.

33. A nozzle as claimed in any previous claim, in which the spray orifice comprises the outlet of the nozzle device.
